(19) United States
(12) Patent Application Publication
(10) Pub. No.: US 2015/0009085 A1
(43) Pub. Date: Jan. 8, 2015

(54) ANTENNA

(71) Applicant: Patrick Lawrence, Chandler, AZ (US)

(72) Inventor: Patrick Lawrence, Chandler, AZ (US)

(21) Appl. No.: 14/326,402

(22) Filed: Jul. 8, 2014

Related U.S. Application Data
(60) Provisional application No. 61/843,881, filed on Jul. 8, 2013.

(51) Int. Cl. H01Q 15/16; H01Q 19/13

(52) U.S. Cl. CPC H01Q 15/161; H01Q 19/13
USPC 343/840; 343/915; 428/221

(57) ABSTRACT

A reflector for an antenna is formed from a metallized fabric composite material including a first fabric layer, a second fabric layer, and a metallic layer positioned between the first and second fabric layers and secured to each of the first and second fabric layers.

### CROSS-REFERENCE TO RELATED APPLICATIONS

This application claims the benefit of U.S. Provisional Application Ser. No. 61/843,881, filed on Jul. 8, 2013, the disclosure of which is incorporated herein by reference in its entirety.

### BACKGROUND OF THE INVENTION

In a highly-mobile first-responder scenario, a first-responder team may be tasked with carrying to carry communications equipment along with other mission-essential and life-support equipment. Thus, the weight of the communications equipment becomes critical, and any reduction in the weight of the equipment would be beneficial.

In addition, the communications equipment may need to perform well in any of a wide variety of environmental conditions, and may also be subject to rough handling and wear. For example, excessive thermal expansion of the reflector and its associated support structure during solar loading may produce undesirable stresses in the reflector material and the connections between the reflector and the support structure. The antenna element must withstand and operate in these conditions. Especially, the desired parabolic shape of the antenna must be maintained under adverse conditions.

The portability of existing communications equipment has been hampered by the size and the weight of the terminal antenna. Due to the nature of the intended use of the antenna, it is desirable to minimize the antenna weight while ensuring that the antenna performs as desired under a wide variety of conditions.

### SUMMARY OF THE INVENTION

In one aspect of the embodiments described herein, a reflector for an antenna is provided. The reflector is formed from a metallized fabric composite material including a first fabric layer, a second fabric layer, and a metallic layer positioned between the first and second fabric layers and secured to each of the first and second fabric layers.

In another aspect of the embodiments of the described herein, an antenna is provided. The antenna includes a reflector formed from a metallized fabric composite material, and a reflector support structure including a plurality of ribs attached to the reflector, the plurality of ribs is structured to be movable to configure the reflector to a stowed condition and to a deployed condition.

In another aspect of the embodiments of the described herein, a metallized fabric composite material is provided. The material includes a first fabric layer, a second fabric layer; and a metallic layer positioned between the first and second fabric layers and secured to each of the first and second fabric layers.

### BRIEF DESCRIPTION OF THE DRAWINGS

FIG. 1 is an exploded view of a sheet of one embodiment of a metallized fabric composite material used to form elements of an antenna reflector member in accordance with an embodiment described herein.

FIG. 2 is a plan view of a template usable for marking boundaries of reflector panels on a sheet as shown in FIG. 1, preparatory to the cutting of reflector panels from the sheet.

FIG. 3 is a plan view of a sheet of metallized fabric composite material as shown in FIG. 1, showing marked portions denoting cut and stitch lines for reflector panels in accordance with an embodiment described herein.

FIG. 4 is a magnified view of a portion of the sheet shown in FIG. 3.

FIG. 5 is a plan view of a single finished reflector panel cut from a sheet as shown in FIG. 3.

FIG. 6 is a plan view of three individual reflector panels arranged side-by-side prior to attachment of the panels to each other.

FIG. 7 is a perspective view showing two reflector sub-assemblies formed from groups of reflector panels attached to each other along connecting seams.

FIG. 8 is a side view of a finished reflector member after attachment of the constituent individual reflector panels to each other, but prior to attachment of the reflector member to a reflector member support structure.

FIG. 9 is a magnified view of the reflector member shown in FIG. 8.

FIG. 10 is a schematic view showing a process of mounting a reflector member onto a shaping form prior to attachment of supporting ribs to the reflector member.

FIG. 11 is a cross-sectional view of a portion of a rib forming part of a support structure for the reflector, and showing a cavity formed by portions of the rib.

FIG. 11A is the rib cross-sectional view of FIG. 11 showing positioning of a portion of the reflector member therein prior to securement of the reflector member portion to the rib.

FIG. 11B is the rib cross-sectional view of FIG. 11A showing the portion of the reflector member pinched and secured between deflectable portions of the rib.

FIG. 12 is a perspective view of an antenna assembly prior to attachment of a reflector thereto, and showing a reflector support structure in a compacted or closed condition.

FIG. 13 is a perspective view similar to FIG. 12 showing the reflector support structure in a fully expanded or deployed configuration.

FIG. 14 is an exploded partial perspective view showing attachment of a portion of a reflector to an associated portion of a reflector support structure.

FIG. 15 is a perspective view of an antenna assembly incorporating a reflector member in accordance with an embodiment described herein, and showing the reflector support structure and the reflector in a fully expanded or deployed configuration.

### DETAILED DESCRIPTION

Like reference numerals refer to like parts throughout the description of several views of the drawings. In addition, while target values are recited for the dimensions of the various features described herein, it is understood that these values may vary slightly due to such factors as manufacturing tolerances, and also that such variations are within the contemplated scope of the embodiments described herein.

The embodiments described herein relate to a low-weight reflector for a man-portable antenna assembly and a novel support structure for supporting the antenna reflector. The support structure maintains the antenna reflector in a compact, folded condition between antenna deployments. The support structure is also actuatable to unfold and expand the reflector for use, to maintain the reflector in the expanded condition during use, and to return the reflector to the compacted state after use.

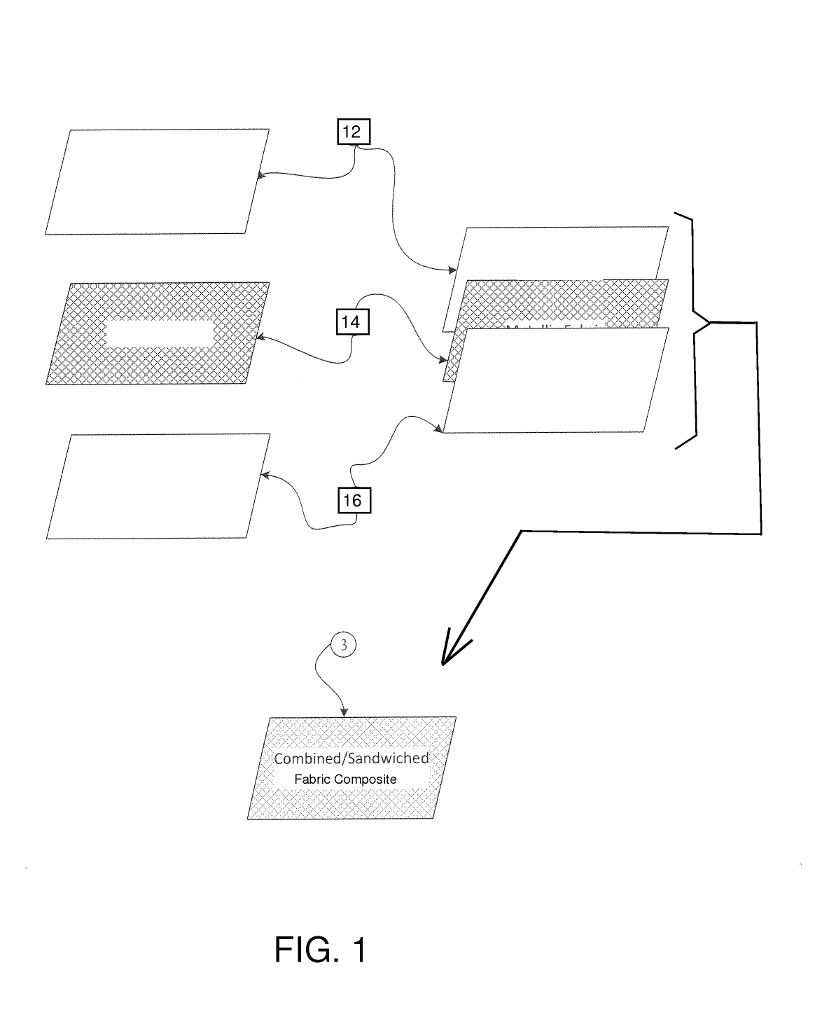

FIG. 1 is an exploded view of a sheet of one embodiment of a novel metallized fabric composite material 3 used to form elements of an antenna reflector member in accordance with an embodiment described herein. In the embodiment shown, a sheet 3 of the composite material is formed from a first layer 12, a second layer 14 and a third layer 16. Second layer 14 is sandwiched between first layer 12 and third layer 16. In a particular embodiment, a finished fabric composite sheet 3 has a diameter within the range be 11-40 inches inclusive.

In a particular embodiment, first layer 12 of the composite material 3 is formed from a 50-100 denier, rip-stop material which may be coated or otherwise treated to enhance such properties as flame resistance, tear resistance and/or resistance to ultra-violet (UV) radiation exposure, for example. In a more particular embodiment, layer 12 is formed from a 70 denier, rip-stop material having the other properties just described. In one embodiment, the material is coated with a polyurethane. In one embodiment, the material is coated with a silicone.

In one embodiment, the first layer material is a polyamide. In another embodiment, the material is a nylon. In yet another embodiment, the material is Kevlar®. However, any of various suitable alternative materials may be used. One source for a material suitable for use in the first layer 12 is Seattle Fabrics, of Seattle, Wash.

Second layer 14 is formed from a metallic material. As used herein, the term “metallic material” refers to a material formed from one or more metals or incorporating one or more metals therein. For example, second layer 14 may be formed from a metallized fabric or a metallic composite material. As known in the art, a metallized fabric may be formed from a suitable fabric (such as a nylon, for example) which may be woven, non-woven, or knit, and is coated with one or more metals, such as silver, nickel or copper, tin, and/or gold. Metallized fabric may be provided by any known distributor or manufacturer of metallic and/or metallized fabrics. An exemplary supplier for the metallized fabric is Marktek, Inc. of Chesterfield, Mo., and may provide various metallized fabric layers having various metal weaves in various thicknesses.

In another particular embodiment, second layer 14 is formed from a pure copper polyester taffeta. In another particular embodiment, second layer 14 is formed from a rip-stop silver fabric. One source for these materials is Less EMF Inc., of Latham N.Y.

Layer 16 may be formed from the same material as layer 12, or layer 16 may be formed from a different material having the same or similar pertinent properties, as described with regard to layer 12.

Referring to FIG. 1, to construct a sheet of the metallized fabric composite 3, layers 12, 14 and 16 are laid out on a flat surface, with the metallic layer 14 sandwiched between fabric layers 12 and 16. Sheets 12, 14 and 16 are then bonded to each other, thereby forming a highly durable and flexible composite fabric sheet 3. Each of layers 12 and 16 may be adhesively bonded to a respective face or side of layer 14. One adhesive suitable for this purpose is a spray-on adhesive, for example, 3M™ Rubber And Vinyl 80 Spray Adhesive, which is a high performance neoprene based contact aerosol spray adhesive, available from 3M Corporation. In addition, recommendations for adhesive compositions suitable for joining particular materials can be provided by suppliers of the materials and/or by various adhesive manufacturers. Alternatively, layers 12, 14 and 16 may be attached to each other using any other attachment method suitable for connecting layers 12, 14 and 16 as described herein.

It has been found that a metallized fabric composite layer fabricated as described herein is particularly suited for reflecting electromagnetic waves. Reflector embodiments constructed from an embodiment of the novel metallized fabric composite material described herein have been found to exhibit high electromagnetic reflectivity, and to provide good reflective performance when used in transmit and receive satellite communications antennas operating at radio frequencies up to and including 30 GHz. These reflector embodiments have also been found to have particular utility for use as parabolic center-fed antenna reflectors for ground-based satellite communications in the C, X, Kᵤ & Kₐ -bands of the electromagnetic spectrum.

In addition, reflector members constructed from an embodiment the novel metallized fabric composite material described herein have been found to have high strength, very low weight per unit volume, low stiffness in the plane of the reflector (which facilitates folding and unfolding of the reflector without creases or wrinkles), high resistance to tearing and weathering, high moisture resistance, and high resistance to structural degradation due to ultraviolet radiation exposure. These reflector embodiments also exhibit a low coefficient of thermal expansion.

In the manner described below, portions of the sheet 3 are cut and stitched or otherwise attached to each other to form a reflector member (or reflector) 50 configured for attachment to a suitable reflector support structure 100 (described in greater detail below).

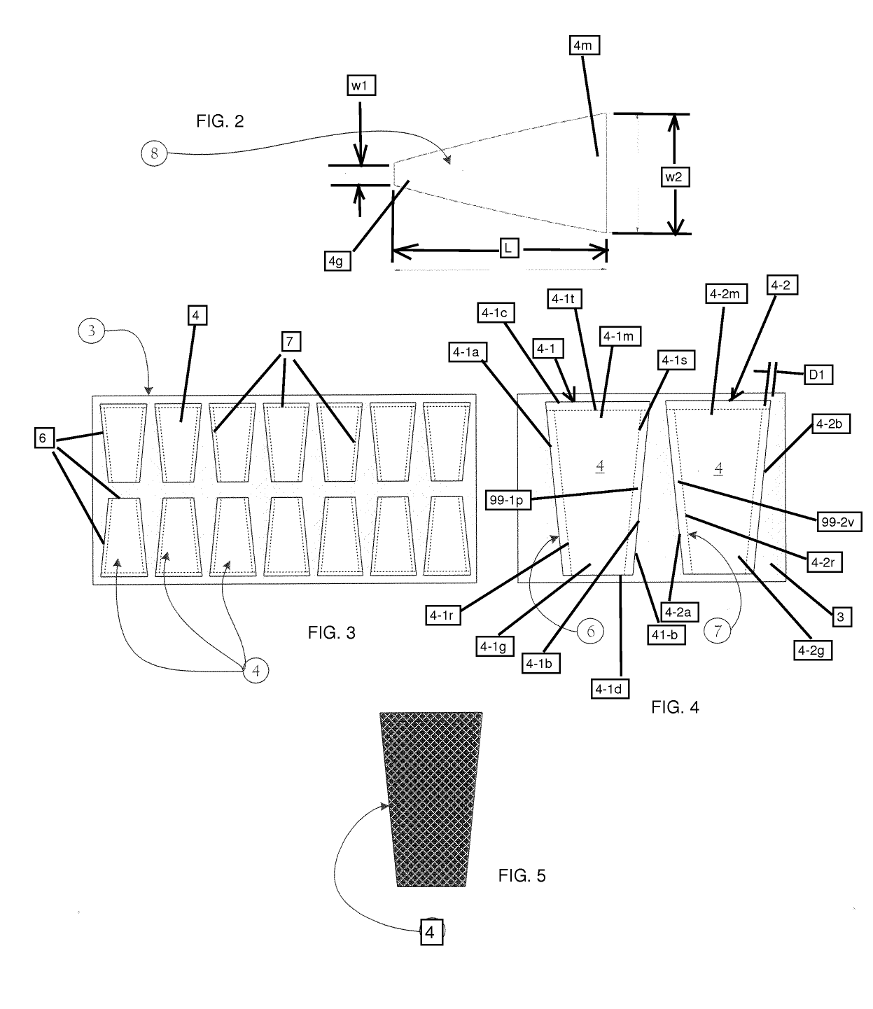

Referring to FIGS. 2-5, the sheet 3 of metallized fabric composite is marked using a template 8 to facilitate cutting of a plurality of reflector panels 4 from the sheet, and to facilitate stitching of the panels together as described in greater detail below. FIG. 2 shows an example of a template 8 usable for marking sheet 3 for the cutting of the reflector panels. The cut panels then have the same basic shape and dimensions as the template. FIG. 3 is a plan view of a sheet of metallized fabric composite material as shown in FIG. 1, showing marked portions denoting cut and stitch lines for reflector panels in accordance with an embodiment described herein. Each panel 4 is marked on sheet 3 by a series of cut lines (collectively designated 6 in FIG. 3 for illustrative purposes) defining the outer edges of the panel, and a series of associated stitch lines (collectively designated 7 in FIG. 3 for illustrative purposes) spaced apart from and parallel to the cut lines, to define the locations of stitches connecting adjacent panels.

Each cut line 6 defines a cut edge of an associated finished panel 4. In one embodiment, a pie-shaped template 8 is used. The template 8 is structured to enable cutting of a panel with a relatively narrower first end 4g having a first dimension w1, a relatively broader or wider second end 4m having second dimension w2 greater than the first dimension, and a length dimension L as shown in FIG. 2. In a particular embodiment, dimension w1 is within the range 0.40 inches to 0.60 inches inclusive, dimension w2 is within the range 2.0 inches to 4.0 inches inclusive, and length L is within the range 4.0 to 6.0 inches, inclusive. In a more particular embodiment, dimension w1 is equal to 0.535 inches, dimension w2 is equal to 2.879 inches, and length L is equal to 5.194 inches.

FIG. 4 shows a pair of panels 4-1 and 4-2 arranged side by side as marked on a portion of a sheet 3 prior to cutting, to illustrate further details of the panels. In the following description, panel 4-1 will be referenced as an exemplary panel. It is understood that all of the remaining panels have features similar to those described for panel 4-1.

Referring to FIG. 4, panel 4-1 as cut will have a relatively narrower first end 4-1g (as previously described), a relatively wider second end 4-1m, and a pair of opposed side edges 4-1a and 4-1b, with another pair of opposed edges 4-1c and 4-1d located at ends 4-1m and 4-1g, respectively. Stitch lines 4-1r, 4-1s and 4-1t are spaced apart from respective ones of each of panel edges 4-1a, 4-1b and 4-1c. Each stitch line extends parallel to its associated edge. In one embodiment, stitch lines 4-1r, 4-1s and 4-1t are spaced apart equal distances from their respective associated panel edges. In a particular embodiment, the spacing distance D1 is within the range 2.5 to 6 inches, inclusive. The distance D1 is specified so as to provide attachment flaps 99 (described in greater detail below) of a predetermined size, which are used for attachment of the finished reflector to a series of ribs (also described in greater detail below).

FIG. 5 is a plan view of a single finished reflector panel 4 cut from a sheet as shown in FIG. 3.

FIG. 6 is a plan view of three individual reflector panels 4 arranged side-by-side prior to attachment of the panels to each other. To connect the panels 4 after cutting, separate, cut panels 4 are arranged adjacent each other and oriented with respect to each other as shown in FIG. 4. Then, the stitch lines extending along the adjacent side edges of the panels are stitched or otherwise attached to each other. For example, after the panels 4-1 and 4-2 have been cut from a sheet 3, these panels would be arranged adjacent each other in the general orientation shown in FIG. 4, and abutting each other along adjacent stitch lines 4-1s and 4-2r. The panels are then stitched to each other along the abutting stitch lines. In a similar manner, additional panels are attached to the unattached side edges of the previously stitched panels until each panel side edge is stitched or otherwise connected to another panel along the stitch lines located along both of its side edges. Because the panels are pie-shaped and are arranged with the relatively narrower first ends adjacent each other, this process results in a generally circular finished reflector member 50, which may then be shaped in later steps into the parabolic configuration shown in FIG. 15.

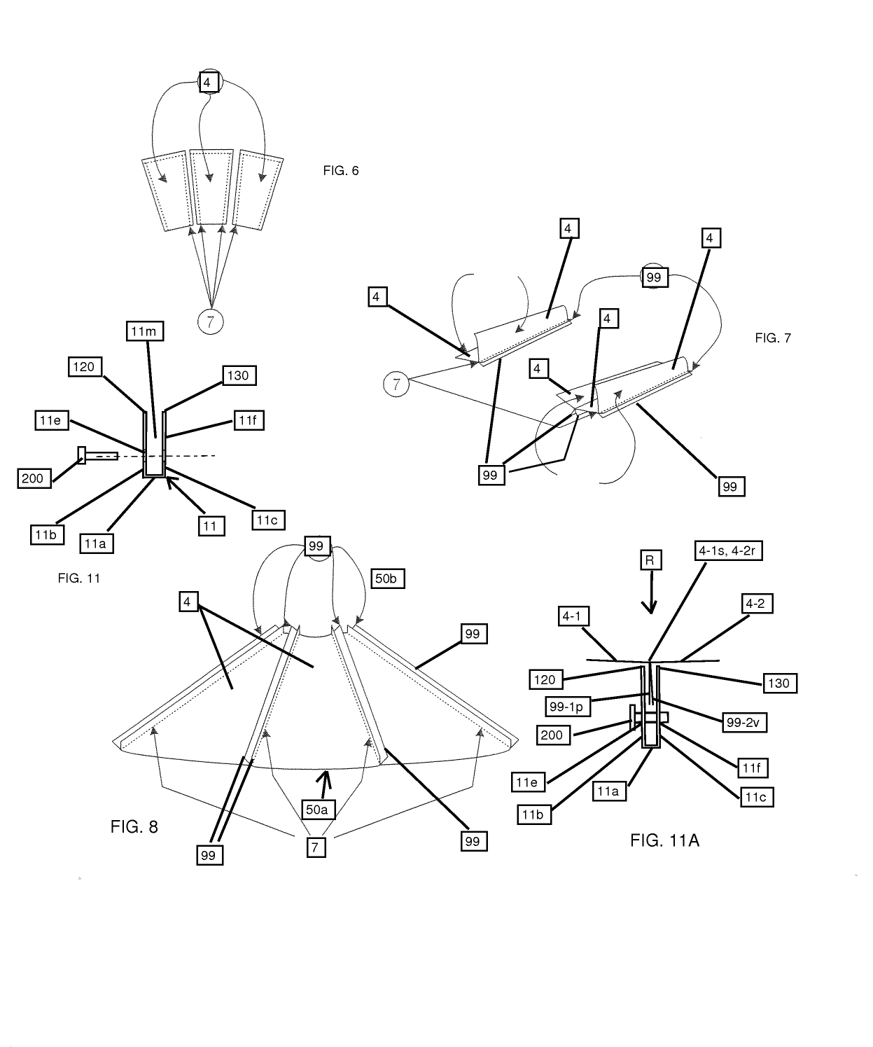

Because the stitch lines associated with the panel side edges are spaced apart from the side edges, when the panels are stitched together along the stitch lines, a flap (generally designated 99) of loose reflector material will be formed between each side edge stitch line and the associated side edge. In the example shown in FIG. 4, these flaps formed between adjacent stitch lines 4-1s and 4-2r are designated 99-1p and 99-2v. After stitching along the adjacent stitch lines 4-1s and 4-2r, these flaps 99-1p and 99-2v will extend from the stitched seam in a direction toward a rear side 50b of the finished reflector member 50 (described in greater detail below). These flaps may be used to attach the reflector member 50 to the ribs 11 of the support structure 100, in a manner described in greater detail below. FIG. 7 is a perspective view showing two reflector sub-assemblies formed from groups of panels attached to each other along connecting seams.

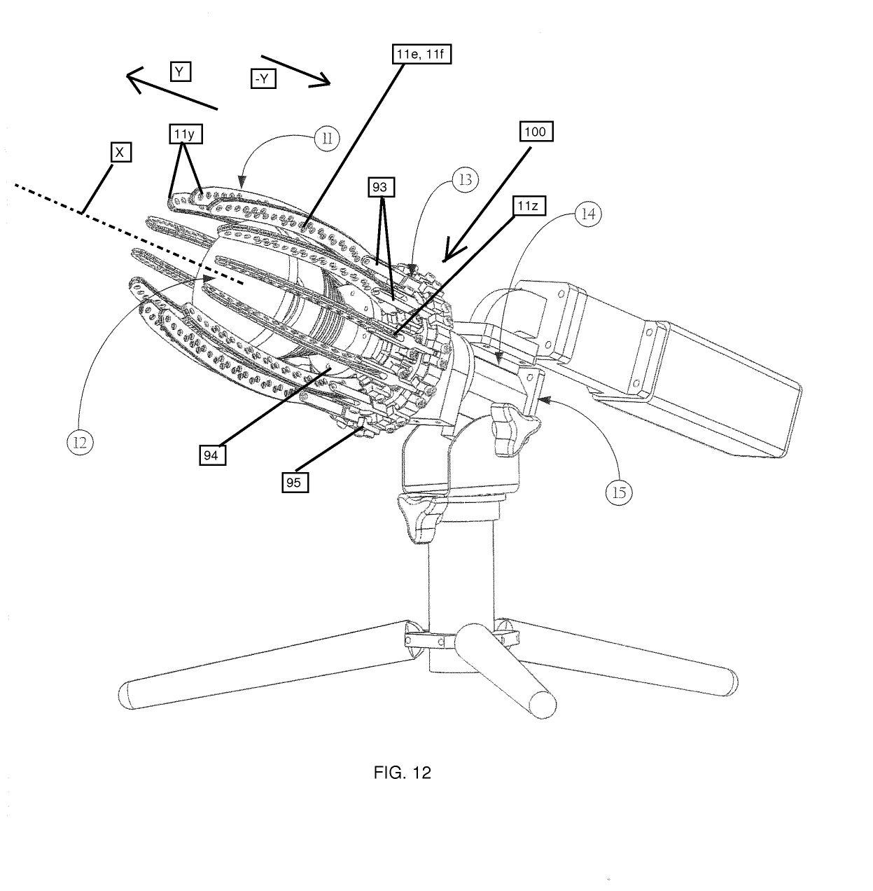

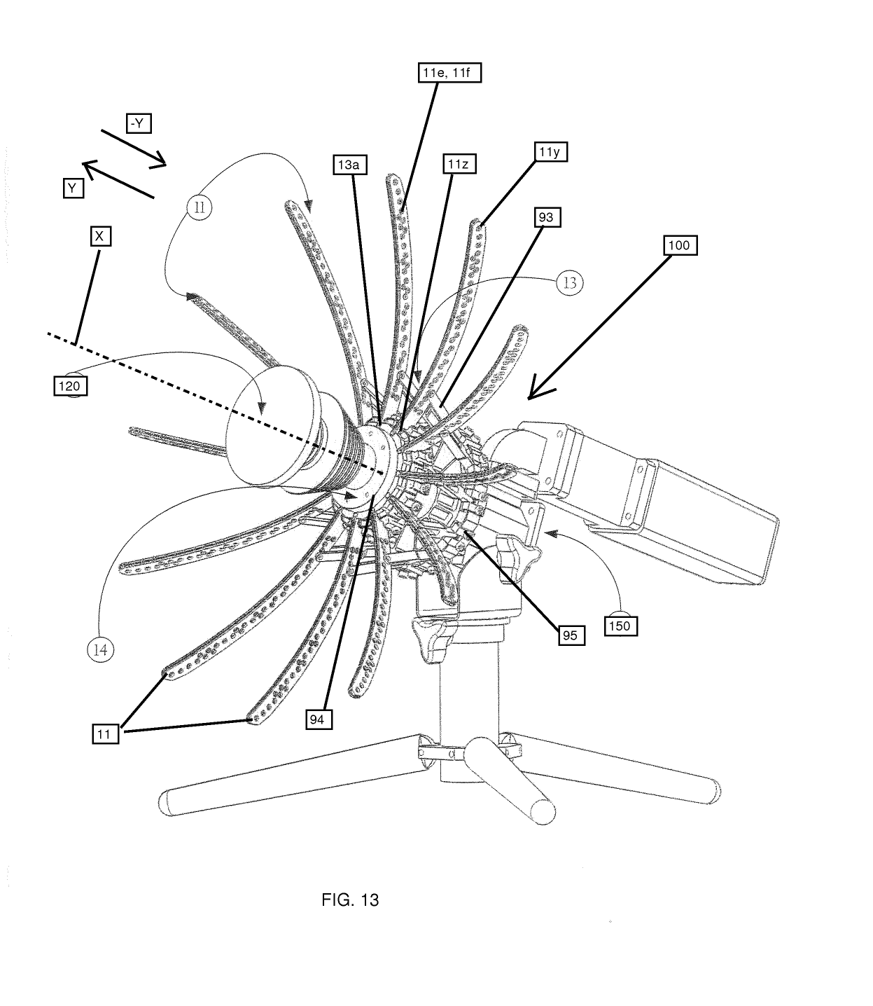

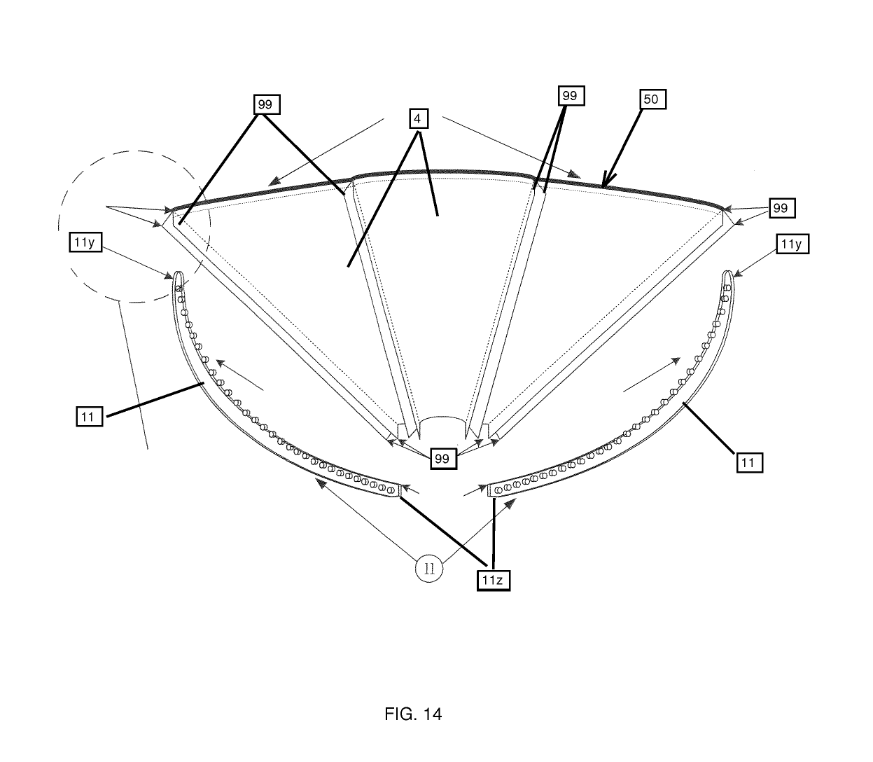

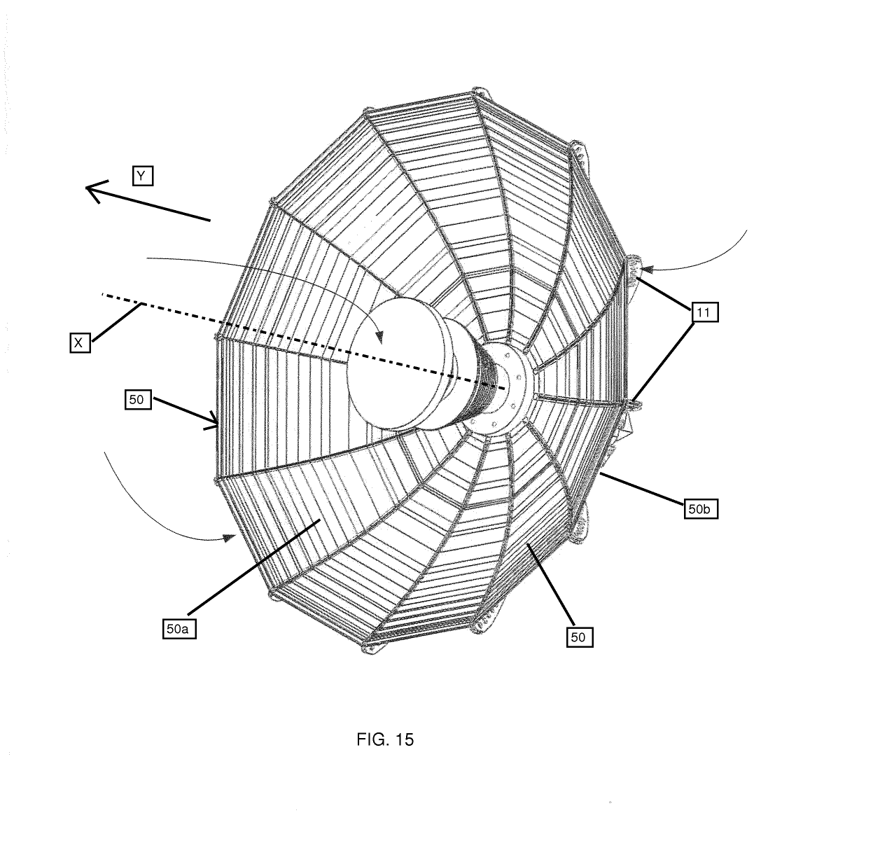

FIG. 12 is a perspective view of an antenna 60 in accordance with one embodiment described herein, showing an associated embodiment of a reflector support structure 100 in a compacted or closed configuration. FIG. 13 is a perspective view similar to FIG. 12 showing the reflector support structure 100 in an expanded or deployed configuration. In the embodiment shown, support structure 100 includes an aluminum or other light-weight metallic center hub assembly 14, and a plurality of supporting ribs 11 operatively coupled to and extending in a direction away from the hub assembly.

Referring to FIGS. 11-11B, in one embodiment, each of ribs 11 has a generally U-shaped cross-section including a base portion 11a, and a pair of opposed parallel wall portions 11b, 11c extending in a first direction from the base portion to define a cavity 11m therebetween. A series of through holes 11e extend along the length of wall portion 11b, and a series of through holes 11f extend along the length of wall portion 11c. Each of holes 11f formed in wall portion 11c is coaxial with an associated hole formed in wall portion 11b, to enable insertion of a screw or bolt through 200 both of the aligned holes. The spacing between wall portions 11b and 11c is specified so as to permit insertion therein of a pair of flaps 99 extending from a line of stitching connecting a pair of adjacent reflector panels, after the panels have been stitched. The ribs 11 are also structured, and the spacing between wall portions 11b and 11c is specified, so as to permit ends 120 and 130 of the wall portions to be forced toward each other after insertion of the flaps 99 therebetween by tightening of the bolts or screws 200, such that the inserted flaps are pinched and secured between the wall portions. This secures an associated portion of the reflector member to a portion of the support structure. The wall portions may be forced toward each other by, for example, screws or bolts 200 extending into the wall portion openings and spanning the distance between the wall portions. When the flaps 99 have been inserted (in direction R) into the gap between the wall portions and secured in position for assembly, the bolts 200 along the rib are tightened to force the rib wall portions toward each other, until the flaps are secured between the wall portions. In the example shown in FIG. 11, flaps 99-1p and 99-2v are inserted between rib wall portions 11b and 11c until the panel material adjacent the flaps rests against the ends of walls 120 and 130. Ends 120 and 130 of the wall portions are then brought together by tightening the bolts 200 positioned in the holes extending along the rib wall portions, thereby pinching the flaps 99-1p and 99-2v between the wall ends 120 and 130 as shown in FIG. 11B.

In addition, each of ribs 11 has a curvature specified such that, collectively, the ribs impart a desired parabolic shape to a reflector attached to the ribs, when the antenna is in the fully deployed condition. Reflector member 50 is attached to the ribs 11 such that inward movement of the ribs (toward a central axis X of the antenna) produces a folding or contraction of the reflector member, while a spreading apart of the ribs produces an opening and stretching of the reflector member into a deployed condition ready for use. In the embodiment shown, antenna central axis X is defined so as to pass through the vertex and the focus of a parabola defined by the reflector member 50 when the member is supported on ribs 11 and in a fully deployed condition.

Each of ribs 11 is attached to the hub assembly 14 by a hinge mechanism 13 that enables movement of the associated rib between the stowed and deployed positions of the reflector. Referring to FIGS. 12 and 13, in a particular embodiment, an end 11z of each rib 11 is connected by an associated hinge 13a to a central portion 94 of the support structure. Each hinge 13a serves as a pivot about which the associated rib 11 will rotate during expansion and folding of the antenna reflector. Each rib 11 is also rotatably connected by a spar 93 to a portion 95 of the hub assembly structured to move with respect to central portion 94, along antenna axis X in directions Y and −Y (away from the antenna and toward the antenna, respectively). Each spar is connected to an associated rib 11 at a location along the rib between hinge 13a and a second end 11y of the rib. Movement of the hub assembly portion 95 along axis X in a direction Y (away from the antenna) causes the ribs 11 to rotate about their respective hinges 13a, causing the ribs to fan outwardly or spread apart from the stowed condition shown in FIG. 12 to the deployed condition shown in FIG. 13. The system is structured so that ribs 11 unfold outwardly simultaneously and at the same rate, thereby unfolding the reflector member 50 which is attached to the ribs 11 in the manner described herein. In this embodiment, the ribs 11 are also operatively coupled to the center hub assembly 14 such that movement of the portion of the hub assembly along axis X in a direction −Y (toward from the antenna) causes the ribs to rotate again about their respective hinges 13a, causing the ribs to draw toward each other simultaneously and at the same rate toward axis X, from the deployed condition shown in FIG. 13 to the stowed condition shown in FIG. 12. The center hub assembly 14 may also provide a mounting base for other antenna elements (such as a transmission and reception feed 120 and an orthogonal mode transducer 150, for example), each of these items being known in the pertinent art and being provided by known suppliers.

Referring to FIG. 15, when mounted to support structure 100 and in a deployed condition, reflector member 50 has a parabolic shape with a concave or front side 50a opening in direction Y, which extends parallel to antenna axis X. Reflector member 50 also has a convex or rear side 50b opposite concave side 50a.

To achieve and maintain the desired parabolic shape of the reflector member 50 when the antenna is deployed, the reflector member 50 is attached to ribs 11 as previously described, along the rear side of the reflector member. The rear side 50b of the reflector member 50 is attached to ribs 11 such that the reflector member rear side follows the curved contours of the ribs. This imparts the desired parabolic shape to the reflector. The attachments are also structured so that the portions of reflector panels extending between ribs 11 are taught when the antenna is in a fully deployed condition, thereby removing or minimizing wrinkles and in the reflector member fabric composite.

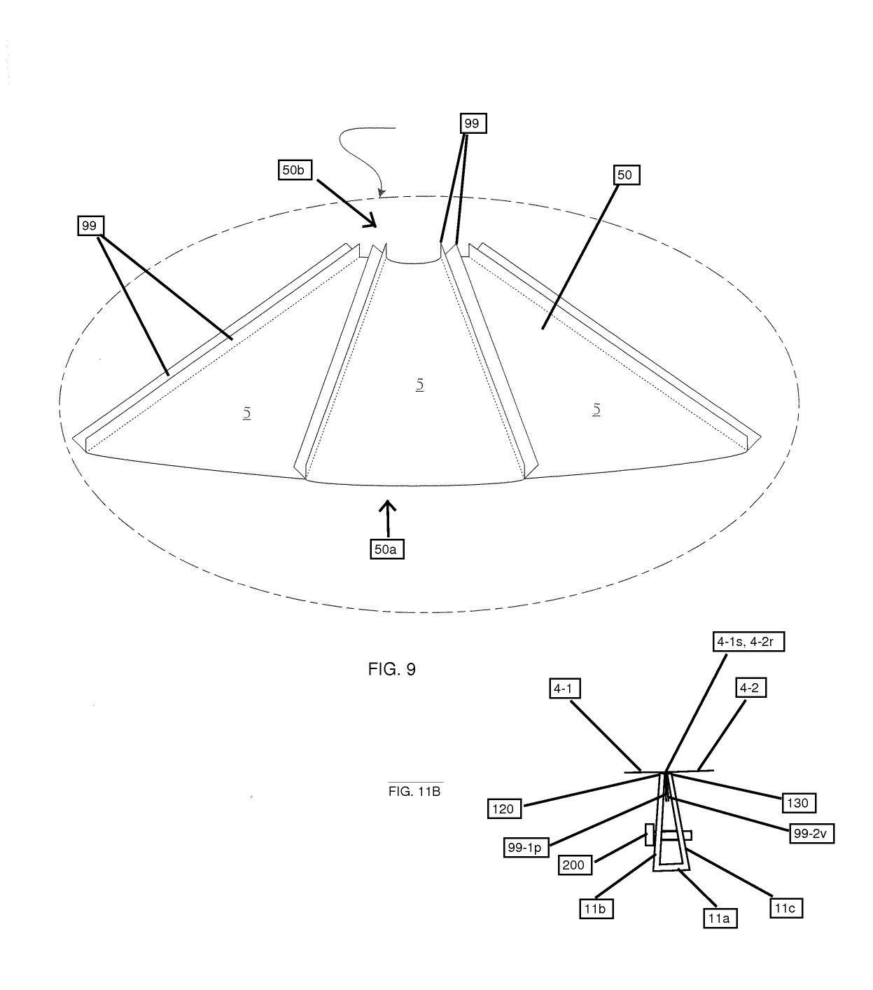

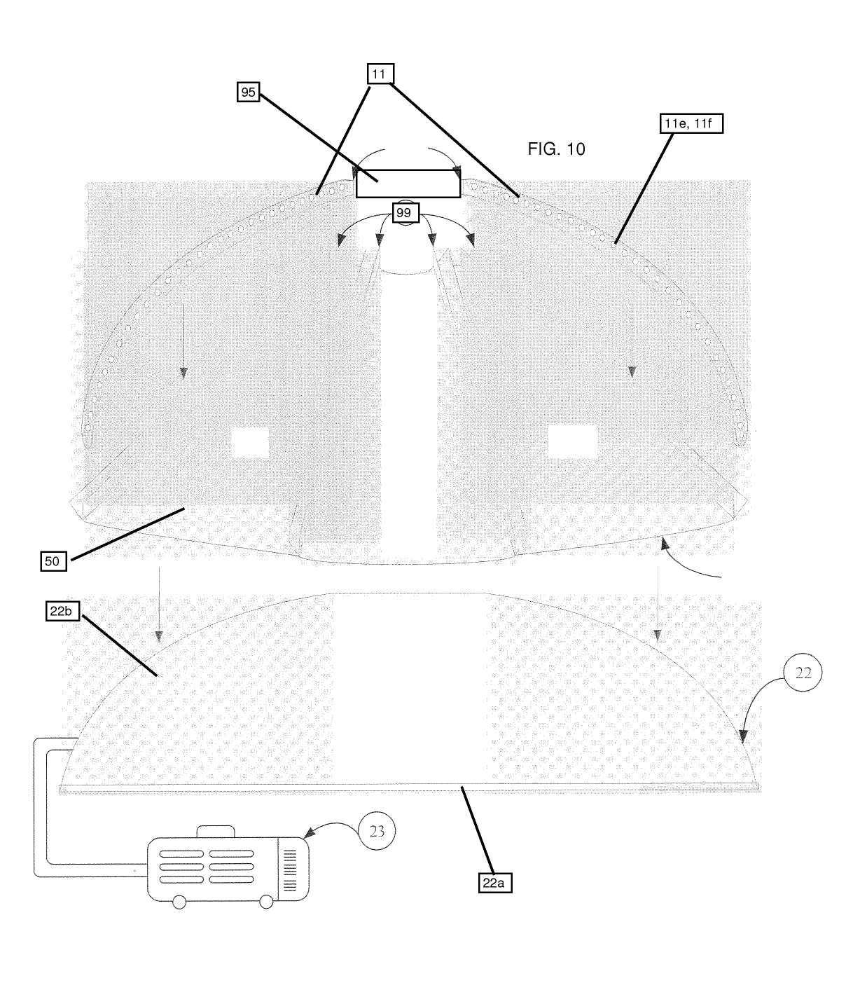

Referring to FIGS. 9 and 10, prior to attaching the reflector member 50 to the ribs 11, the reflector member 50 is positioned and secured in the configuration it will have during full deployment of the antenna. In one example, a form 22 is provided which has the same parabolic shape of the fully deployed reflector member. The form is designed to impart the desired parabolic shape to the reflector, and to maintain the reflector member in the desired shape during attachment of the ribs 11 to the reflector. The form 22 may be molded or fabricated using any suitable manufacturing method. The form 22 is hollow and has base 22a and a securement face 22b secured to the base so as to form a gas-tight seal therebetween. Securement face 22b has the same parabolic shape of the fully deployed reflector member, and also the same curvature as ribs 11.

The hollow interior of the form is operatively coupled to a vacuum pump 23. A plurality of openings (not shown) is distributed along the form securement face to enable fluid communication between the exterior and the interior of the form 22. To secure the reflector member in the full deployment configuration for antenna assembly, the reflector member concave or front side 50a is stretched over the molded form outer securement face 22b. Attention is made to ensure that the reflector member front face 10 is completely taught, and that wrinkles and air bubbles are removed.

Next, the vacuum pump 23 is activated to draw the air from the interior of the form. The reflector member 50 is thus secured against form securement face 22b by atmospheric pressure. The applied vacuum may be sufficient to secure the reflector member to the securement face 22b, while still permitting a degree of positional adjustment of the reflector member with respect to the securement face. Ribs 11 may be hingedly attached to movable hub assembly portion 95 so as to be rotatably manipulable with respect to the hub assembly portion during attachment of the ribs to the reflector member 50.

In the example shown in FIG. 11, flaps 99-1p and 99-2v are inserted between rib wall portions 11b and 11c until the panel material adjacent the flaps rests against the ends of walls 120 and 130. The rib wall ends 120 and 130 can be pressed against the reflector member 50, which is braced against securement face 22b. This helps ensure positioning and retention of the flaps 99 between respective walls of the ribs during attachment of the reflector member to the ribs.

Prior to completely tightening the bolts 200 to pinch and secure the flaps between the rib walls, careful attention is made to ensure the front face of the reflector member 50 is completely taught and flush against the securement face 22b. This is ensured by pulling on the radially outermost edge of each panel of the reflector member 50. For example, the radially outermost edge of panel 4-1 in FIG. 4 is edge 4-1c. The radially outermost edges of the panels are pulled in directions radially away from the center of the reflector member. Any excess reflector material extending along the radially outermost edges after tightening of the bolts may be trimmed off of the reflector member.

With the reflector member secured flush against securement face 22b and each of the flaps positioned between the opposed wall portions of a respective rib, the reflector member is attached to the ribs 11 by tightening the bolts 200, as previously described. Bolts along each rib 11 may be tightened sequentially until all the bolts on all the ribs have been tightened, starting near the center of the reflector member and proceeding outwardly along the lengths of the ribs.

When the vacuum is removed from the form interior, the reflector member 50 and the attached ribs may be removed from form securement face 22b. When the reflector member 50 and attached ribs are mounted on the form 22, the reflector member and ribs are in the fully deployed configuration of the reflector member. Means may be provided for securing the reflector member and ribs in this configuration until the mounting member from which the ribs extend can be operatively coupled to the remainder of the antenna assembly.

Known elements of the antenna assembly other than the reflector member 50, ribs 11, and other elements described in detail herein, may be made as known in the art or procured from known sources.

During operation of the antenna, the ribs 11 of the support structure are spread apart from the configuration shown in FIG. 12 to the configuration shown in FIG. 13 to deploy the reflector. This results in the fully deployed, parabolic configuration of the reflector shown in FIG. 15. When the antenna is fully opened, the antenna can be connected to a known feed and orthogonal mode transducer (OMT) to complete the functional aspect of the reflector.

Each of the embodiments described herein provides an extremely lightweight variable-form compact antenna system which can be configured to transmit and receive radio-frequency signals antenna for duplex communications via satellite. Those skilled in the art will appreciate that a practical implementation of an embodiment described herein is as a backpack transportable system weighing 10 lbs. or less. This antenna may be incorporated into a compact, lightweight communications terminal that is designed for single-person transport and easy set-up, to enable access to geo-synchronous satellites for first responder applications. The relatively low antenna weight allows a first responder team to carry more mission-essential and life support equipment

It will be understood that the foregoing descriptions of the various embodiments are for illustrative purposes only. As such, the various structural and operational features herein disclosed are susceptible to a number of modifications, none of which departs from the scope of the appended claims.

What is claimed is:

1. A reflector for an antenna, the reflector comprising a metallized fabric composite material including:
a first fabric layer;
a second fabric layer; and
a metallic layer positioned between the first and second fabric layers and secured to each of the first and second fabric layers.

2. The reflector of claim 1 wherein the first fabric layer is formed from a 50-100 denier, rip-stop material.

3. The reflector of claim 1 wherein the first fabric layer material is a polyamide.

4. The reflector of claim 1 wherein the first fabric layer material is a nylon.

5. The reflector of claim 1 wherein the first fabric layer material is Kevlar®.

6. The reflector of claim 1 wherein the first fabric layer material is coated with one of a polyurethane and a silicone.

7. The reflector of claim 1 wherein the metallic layer is formed from a metallized fabric

8. The reflector of claim 1 wherein the metallic layer is formed from a metallic composite material.

9. The reflector of claim 1 wherein the metallic layer is formed from a pure copper polyester taffeta.

10. The reflector of claim 1 wherein the metallic layer is formed from a rip-stop silver fabric.

11. The reflector of claim 1 wherein the second fabric layer is formed from the same material as the first fabric layer.

12. An antenna comprising a reflector in accordance with claim 1.

13. An antenna comprising:
a reflector formed from a metallized fabric composite material; and
a reflector support structure including a plurality of ribs attached to the reflector, wherein the plurality of ribs is structured to be movable to configure the reflector to a stowed condition and to a deployed condition.

14. The antenna of claim 13 wherein the reflector includes a plurality of flaps extending therefrom, and wherein the reflector is attached to the plurality of ribs by flaps of the plurality of flaps attached to associated ribs of the plurality of ribs.

15. The antenna of claim 14 wherein each rib of the plurality of ribs includes a pair of opposed wall portions, and wherein flaps of the plurality of flaps are secured an associated rib by pinching the flaps of the plurality of flaps between the wall portions of the associated rib.

16. The antenna of claim 14 wherein each rib of the plurality of ribs defines a cavity therein, and wherein flaps of the plurality of flaps are secured within each cavity.

17. A metallized fabric composite material comprising:
a first fabric layer;
a second fabric layer; and
a metallic layer positioned between the first and second fabric layers and secured to each of the first and second fabric layers.
